(19) United States
(12) Patent Application Publication
(10) Pub. No.: US 2022/0260900 A1
(43) Pub. Date: Aug. 18, 2022

(54) WEARABLE DEVICE AND RELATED METHODS FOR PRESENTING MOTION PICTURES

(71) Applicant: Aviva Brandes-Krug, Medford, MA (US)

(72) Inventor: Aviva Brandes-Krug, Medford, MA (US)

(21) Appl. No.: 17/672,409

(22) Filed: Feb. 15, 2022

Related U.S. Application Data
(60) Provisional application No. 63/150,499, filed on Feb. 17, 2021.

(51) Int. Cl. G03B 25/02

(52) U.S. Cl. CPC G03B 25/02

(57) ABSTRACT

A wearable device including an aperture configured for placement about a body part, a base configured for remaining adjacent the body part when the aperture is in place about the body part, a panel configured for movement relative to the base, wherein the base includes an outwardly facing surface presenting an image, the image includes a number of adjacent frames in a sequence forming a motion picture, and the panel includes a plurality of evenly spaced openings through which the frames are viewable one at a time in sequence as the panel moves relative to the base.

### CROSS-REFERENCE TO RELATED APPLICATION

The present invention claims priority from the following U.S. Provisional Application, the entire disclosure of which, including but not limited to any and all cited references, is incorporated herein by reference: U.S. Provisional Application No. 63/150,499 (filed Feb. 17, 2021).

### FIELD OF THE INVENTION

The present general inventive concept relates to apparatus and methods related to wearable devices configured to mechanically present motion pictures, and more particularly to apparatus and methods related to wearable devices configured to display motion pictures when rotated.

### BACKGROUND OF THE INVENTION

Attractive wearable items have long been fashionable. Jewelry was originally formed from plain metal with no additional design elements. Later, static design elements were added in the form of gems or patterns. A later evolution of jewelry added functionality.

Watches are an example of functional jewelry. Other functional wearable devices include rings that light up, and necklaces with pendants that open to reveal a picture.

Wearable devices having functionality provided by electronic components have increased in popularity as computer technology becomes more and more advanced. However, the increased popularity of wearable electronics has also spawned a desire for functional wearable devices with novelties that do not rely on electronic components or artificial power sources.

However, functions provided by existing functional wearable devices that do not rely on electronic components or artificial power sources are limited to minimal functions.

Accordingly, there is a need for functional wearable devices that do not rely on electronic components or artificial power sources but that provide attractive and advanced functions.

In addition, it has been recognized that it can be fun or necessary for people to fidget with a toy or other gadget in order to address attention inconsistencies or otherwise provide sensory stimulation. Existing fidget toys and gadgets that provide sensory stimulation can be noisy or distracting to fidgeters or others around them, and in many cases offer an undesirably low level of visual stimulation.

Accordingly, there is a need for a fidget device that provides interesting stimulation without being visually or audibly distracting.

### SUMMARY OF THE INVENTION

The above-described needs are met by the present general inventive concept, which provides apparatus and methods related to wearable devices configured to mechanically present motion pictures.

In preferred apparatus embodiments, a wearable device of the present invention includes an aperture configured for placement about a body part, a base configured for remaining adjacent the body part when the aperture is in place about the body part, and a panel configured for movement relative to the base. Preferably, the aperture is configured for fitting placement about the body part. Preferably, the base is configured for remaining stationary adjacent the body part when the aperture is in place about the body part.

Further in preferred embodiments, the base includes an outwardly facing surface presenting an image, the image includes a number of adjacent frames in a sequence forming a motion picture, and the panel includes a plurality of evenly spaced openings through which the frames are viewable one at a time in sequence as the panel moves relative to the base.

Further in preferred embodiments, the base includes an inner cylindrical band forming the aperture and having the outwardly facing surface, and the panel includes an outer cylindrical band concentric with the inner cylindrical band such that the outwardly facing surface is visible through the openings. Preferably, the inner cylindrical band forms an inner cylinder, the outer cylindrical band forms an outer cylinder and the bands are configured for rotational movement relative to one another about the longitudinal axis of the cylinders and constrained relative to one another in a direction parallel to the longitudinal axis of the cylinders.

Further in preferred embodiments, as to each frame, each frame is included in the image as a plurality of evenly spaced slices of the frame that when viewed together present the frame. Preferably, each frame has a same number of slices as every other frame, and the slices of the frames are sequentially interlaced to form the image. Preferably, each opening has an opening width, the openings are spaced from adjacent openings by a spacing distance, each slice of the frame has a slice width equal to the opening width, and the slices of the frame are spaced from adjacent slices of the frame by a slice distance equal to the spacing distance. Further preferably, the spacing distance is equal to the opening width multiplied by one less than the number of frames in the sequence.

In preferred embodiments, a first frame of the sequence appears to follow sequentially from a last frame of the sequence such that continuous movement is perceived as the frames are repeatedly viewed sequentially in a loop.

In preferred method embodiments, a method of the invention for preparing a motion picture for presentation is for preparing a motion picture for presentation on a viewing surface of a viewing device having an aperture, a base having the viewing surface, and a panel configured for movement relative to the base and including a plurality of evenly spaced openings each having an opening width and being spaced from adjacent openings by a spacing distance.

In preferred embodiments, the method includes preparing a number of adjacent frames in a sequence forming the motion picture. Preferably, a first frame of the sequence appears to follow sequentially from a last frame of the sequence such that continuous movement is perceived as the frames are repeatedly viewed sequentially in a loop. Preferably, the frames are prepared as silhouettes.

In preferred embodiments, the method includes, as to each frame, converting the frame into a plurality of evenly spaced slices of the frame that when viewed together present the frame, such that each slice of the frame has a slice width equal to the opening width, the slices of the frame are spaced from adjacent slices of the frame by a slice distance equal to the spacing distance, and each frame has a same number of slices as every other frame. Preferably, the spacing distance is equal to the opening width multiplied by one less than the number of frames in the sequence.

In preferred embodiments, the method includes sequentially interlacing the slices of the frames to form an interlaced image.

In preferred embodiments, the method includes preparing a series image to fit a length of the viewing surface by duplicating end-to-end in series the interlaced image.

Preferably, the viewing surface is cylindrical and has a circumference, and the length equals the circumference.

In preferred embodiments, the method further includes applying the series image to the viewing surface.

In additional preferred method embodiments, a method of the invention for user-directed motion picture preparation for presentation is for user-directed preparation of a motion picture for presentation on a viewing surface of a viewing device having an aperture, a base having the viewing surface, and a panel configured for movement relative to the base and including a plurality of evenly spaced openings each having an opening width and being spaced from adjacent openings by a spacing distance.

In preferred embodiments, the method includes providing an image repository and a frame submitter configured to enable a user to submit a plurality of frames of an animation.

Preferably, the user has been provided with one or more guidelines providing direction for optimizing the frames for preparation.

In preferred embodiments, the method includes providing one or more animations from which the user can pick a preferred animation for an intended action including but not limited to one or more of the following: (1) use as-is for preparation for presentation; and (2) retrieve for modification and re-submit.

In preferred embodiments, the method includes providing an animation pattern generator configured to convert submitted frames into an interlaced frame sequence, and an activator configured to enable the user to use the animation pattern generator to convert the user's submitted frames into an interlaced frame sequence.

Preferably, the animation pattern generator is configured to present a preview of an animation based on the generated interlaced frame sequence and/or present a photorealistic three dimensional rendering of a viewing device of the present invention that would present the previewed animation.

In preferred embodiments, the method includes providing an animation pattern editor configured to enable the user to edit the animation pattern generated by the animation pattern generator.

Preferably, the animation pattern editor is configured to enable the user with editing tools.

In preferred embodiments, the method includes providing a user account manager configured to manage user accounts. Preferably, the animation pattern generator and/or the animation pattern editor is configured to save the animation pattern to the user's account.

In preferred embodiments, the method includes providing a print manager configured to enable the user to utilize print templates and/or print animation patterns.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view of a wearable device of an embodiment of the present invention.

FIG. 2 is an exploded perspective view of the wearable device of FIG. 1 showing a base including interlaced slices of a sequence of frames and a rotatable panel with openings through which the base can be viewed.

FIG. 3 is a perspective view of the base of FIG. 2.

FIG. 4 is a side view of the wearable device of FIG. 1 showing a first frame in the sequence of frames.

FIG. 5 is a side view of the wearable device of FIG. 1 showing a second frame in the sequence of frames.

FIG. 6 is a side view of the wearable device of FIG. 1 showing a third frame in the sequence of frames.

FIG. 7 is a side view of a wearable device of another embodiment of the present invention, showing a first frame in the sequence of frames similar to that of FIG. 4.

FIG. 8 is a side view of the wearable device of FIG. 7 showing a second frame in the sequence of frames similar to that of FIG. 5.

FIG. 9 is a side view of the wearable device of FIG. 7 showing a third frame in the sequence of frames similar to that of FIG. 6.

FIG. 10 is an exploded view of the wearable device of FIG. 7.

FIG. 11 is a partially assembled view of the wearable device of FIG. 7.

FIG. 12 is a perspective view of a base top of the wearable device of FIG. 7.

FIG. 13 is a perspective view of a panel of the wearable device of FIG. 7.

FIG. 14 is a perspective view of a base bottom of the wearable device of FIG. 7.

FIG. 15 is a side view of the rotatable panel and the base of a wearable device of an embodiment of the present invention.

FIGS. 16 and 17 are illustrations of a frame slice structure of a series image of an embodiment of the present invention.

FIG. 18 is a flowchart of a method of motion picture preparation of an embodiment of the present invention.

FIG. 19 is a flowchart of a method of user-directed motion picture preparation of an embodiment of the present invention.

### DESCRIPTION OF EXAMPLE EMBODIMENTS

The present inventive concept will now be described more fully with reference to the accompanying drawings, in which exemplary embodiments of the present general inventive concept are illustrated. The inventive concept may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals refer to like elements throughout.

In preferred embodiments of the present general inventive concept, the invention provides apparatus and methods related to wearable devices configured to mechanically present motion pictures.

Non-limiting examples of wearable devices according to embodiments of the present invention include rings, bracelets, necklaces, and other wearable items. While examples discussing a ring as a wearable device is described in detail herein, it should be understood that the same features and methods can be applied to enable other wearable devices to present a motion picture, without departing from the scope and spirit of the present invention.

In certain embodiments, the present invention provides a device and method related to a ring, such as a motion picture ring, for displaying a sequence of images, as frames of a motion picture, in which the images are made to appear to move when the ring is rotated.

### Apparatus

In preferred embodiments, a wearable device of the present invention includes an aperture configured for placement about a body part, a base configured for remaining adjacent the body part when the aperture is in place about the body part, and a panel configured for movement relative to the base.

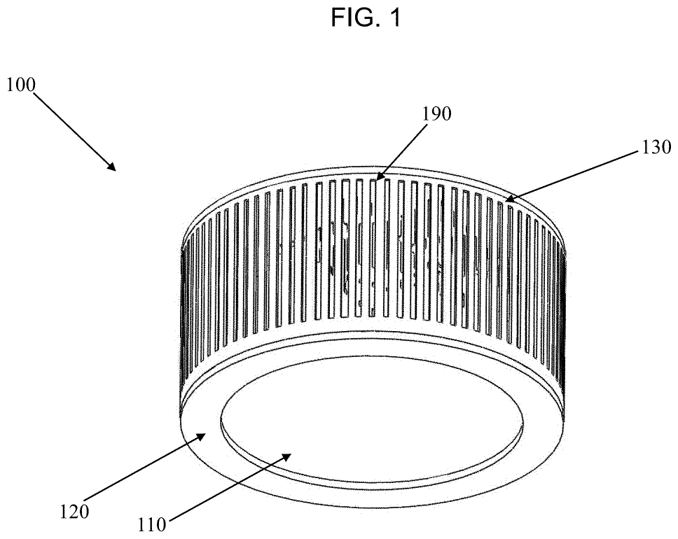

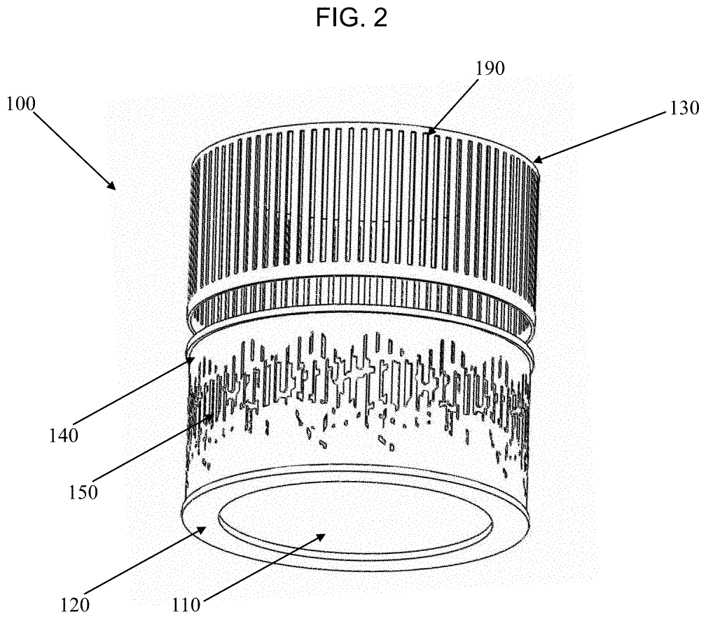

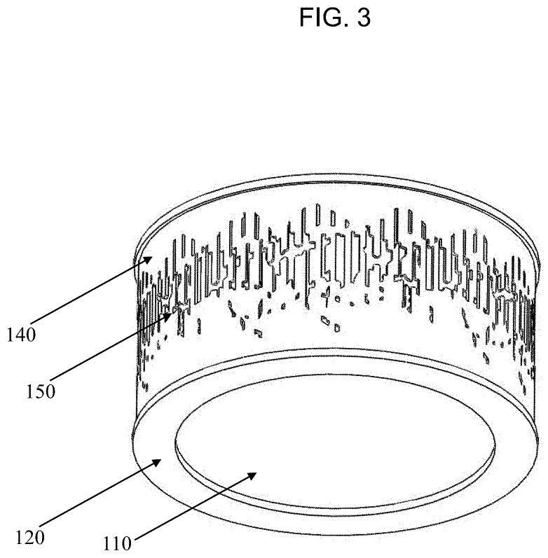

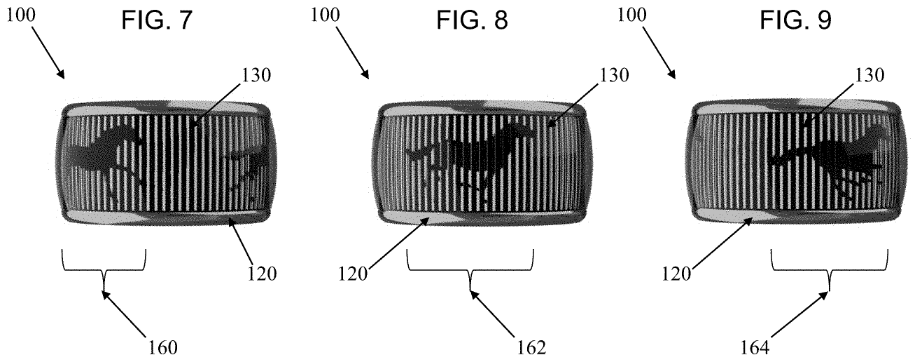

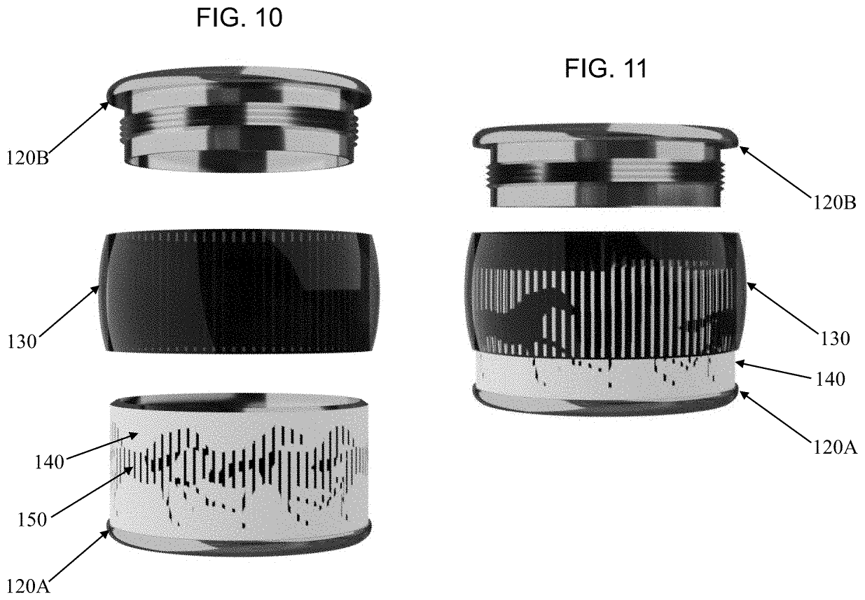

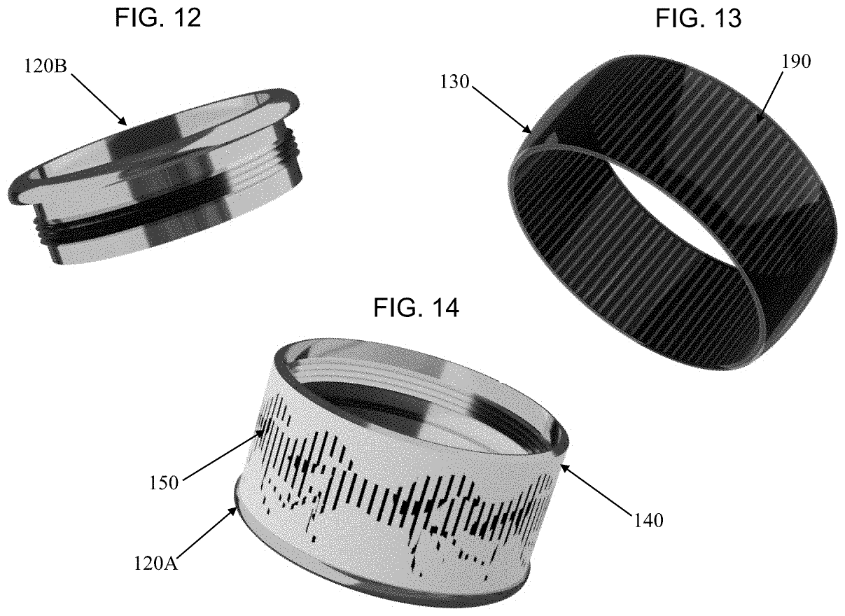

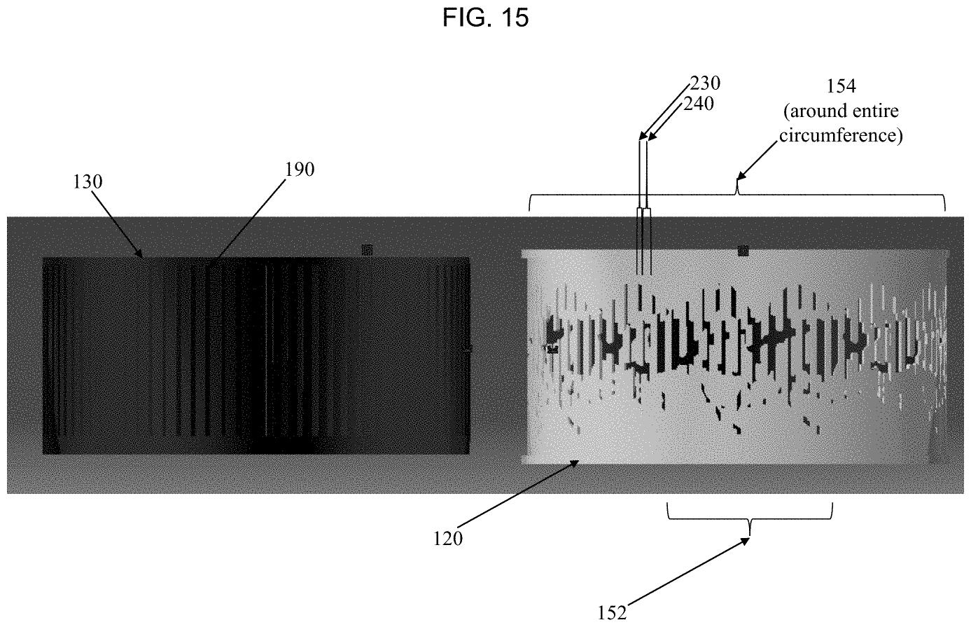

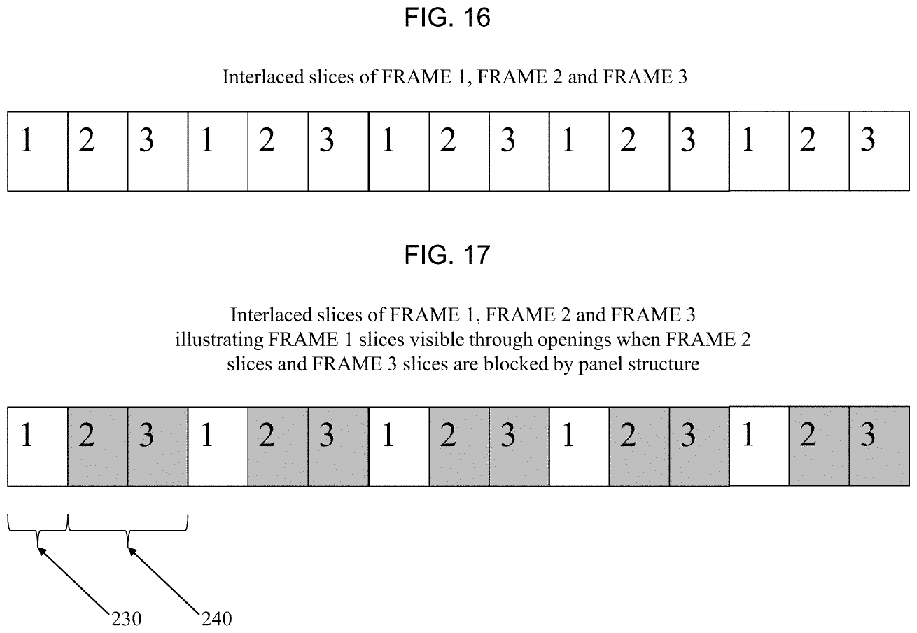

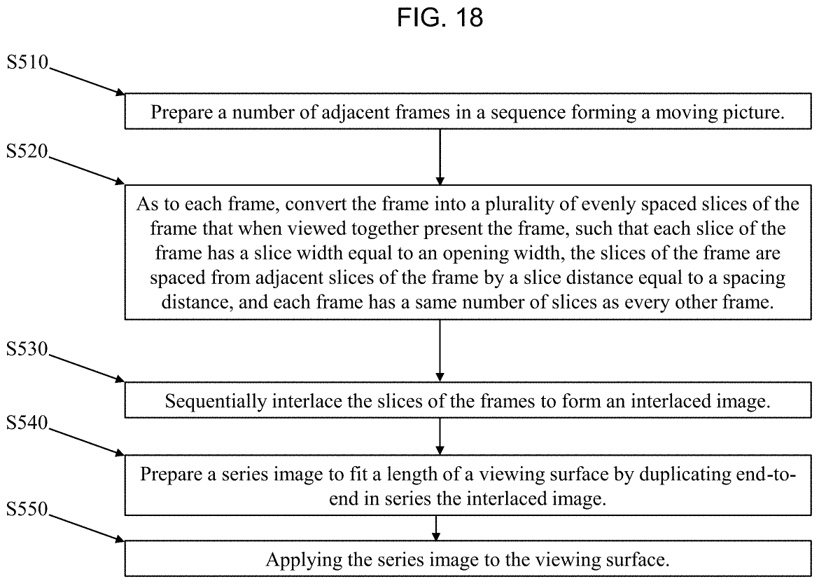

Referring now to FIGS. 1-17, in which is illustrated two non-limiting examples of a wearable device of a preferred embodiment of the present invention, with one being primarily depicted in FIGS. 1-6 and another being primarily depicted in FIGS. 7-14. However, as both embodiments shared similar elements, those are like numbered. FIGS. 15-17 illustrate features of both embodiments. The method of the present invention illustrated in FIG. 18 and described below is applicable to both embodiments.

Illustrated for the aforementioned non-limiting examples is a wearable device of a preferred embodiment of the present invention in the form of a ring 100. As shown, the illustrated ring 100 has an aperture 110 configured for placement about a finger, a base 120 configured for remaining adjacent the finger when the aperture 110 is in place about the finger, and a panel 130 configured for movement relative to the base 120.

In the embodiment primarily depicted in FIGS. 7-15, the base 120 includes a base bottom 120A and a base top 120B that can be secured to one another, preferably by cooperating threads as shown. In the embodiment primarily depicted in FIGS. 7-15, the ring 100 is assembled by placing the panel 130 over the base bottom 120A and then screwing the base top 120B onto the base bottom 120A. Preferably, the two part base 120 is turned from steel (e.g., 304, 316, or 316L) with a CNC screw machine.

Preferably, the aperture is configured for fitting placement about the body part.

In the illustrated example, the aperture 110 is configured for fitting placement about the finger. That is, the aperture 110 is sized and/or shaped to have a diameter comfortably greater than a diameter necessary to put the ring on and pull the ring off a desired finger and to comfortably be worn on the finger for extended periods of time.

Preferably, the base is configured for remaining stationary adjacent the body part when the aperture is in place about the body part.

In the illustrated example, the base 120 is configured for remaining stationary adjacent the finger when the aperture 110 is in place about the finger. That is, the base 120 is sized and/or shaped to fit against the finger with minimal movement relative to the finger during desired activities.

It should be understood that, optionally, the base 120 may be rotated around the finger while the panel 130 is not rotated with respect to the base 120. In such a case, a stationary picture (e.g., one of the frames) is displayed by the ring 100.

Further in preferred embodiments, the base includes an outwardly facing surface presenting an image, the image includes a number of adjacent frames in a sequence forming a motion picture, and the panel includes a plurality of evenly spaced openings through which the frames are viewable one at a time in sequence as the panel moves relative to the base. The image referred to herein can in certain embodiments be considered and/or referred to as an animation pattern.

In the illustrated example, the base 120 includes an outwardly facing surface 140 presenting an image 150 that includes three adjacent frames 160,162,164 in a sequence forming a motion picture. Further in the illustrated example, the panel 130 includes a plurality of evenly spaced openings 190 through which the frames 160,162,164 are viewable one at a time in sequence as the panel 130 moves relative to the base 120.

In the present embodiment, the resolution of the animation is dependent on the height of the animation pattern in relation to the total width of one full cycle of frames. To maintain the quality of the animation, the optimal resolution of the animation pattern is greater than or equal to 12 full frame cycles per cm². Considering visual acuity, the larger the width of each frame, the higher the animation clarity will be. The larger the frame width the lower the resolution will be. Based on the average visual acuity at two feet, the optimal frame width should be greater than or equal to 0.18 mm. The number of frames in the animation pattern should consider the frame width, as the number of frames multiplied by the frame width determines the resolution. The following equations represent how to calculate the resolution, and the minimum viable resolution and frame width respectively:

$$R = \frac{10}{F \times W} R \geq 12 W \geq 0.18$$

where R is the resolution represented as frame cycles per cm2, F is the number of frames per cycle and W is the width of each individual frame in millimeters. From these equations, it can be determined that the optimal number of frames is 2-4 and the optimal range for frame width is 0.18 mm-0.41 mm.

For optimal visibility through the openings 190, the thickness of panel 130 should be ≤40% of the frame width. In addition, a clear material (e.g., acrylic, resin, etc.) can be added to panel 130 to provide both durability and a magnifying quality. Magnification will allow for a clearer and smoother animation. The following is an equation demonstrating the effect of magnification on the minimum viable frame width:

w=M×0.18

where w is the minimum viable frame width in millimeters at any given value of M (the magnification factor), with 0.18 being the minimum viable frame width in millimeters without magnification based on the average visual acuity at two feet. Additionally, any glare resulting from the addition of the clear material can be reduced or removed by the following processes: sanding or other forms of mild surface abrasion, the addition of an anti-glare coating.

The diameter of the outer surface 140 should be only slightly smaller than the inner diameter of panel 130. The surfaces require close contact to allow for smooth animation. A 0.10 mm difference in diameter is enough to allow for a smooth rotation and clear animation.

It should be understood that any number of frames may be used, however, two to four frames is preferred, and three frames is most preferred. A higher number of frames provides a lower resolution for each frame, but a smoother animation effect.

It should further be understood that the width of the openings, the distance between the openings, and the width of the frames may be altered to increase or decrease the resolution of the individual frames.

The structure of the panel 130 between the openings 190 can be considered to be an interference bar or interference bars, in that the structure blocks from view the slices of the frames that are not to be viewed while the slices of the frame to be viewed can be seen through the openings 190.

It should be understood that the openings can be cutouts in the panel structure, or formed by missing panel structure, or be fully or partially transparent windows of solid clear or partially clear material.

It should be understood that the structure of the panel 130 may be any suitable material and may be created by any suitable process including but not limited to 2D or 3D printing, casting, laser cutting, computerized cutting, chemical etching, and applying an opaque material onto a clear material. For example, the panel 130 may be cast from epoxy resin and the openings can be formed by the space left after interference bars are chemically etched on the panel from brass (e.g., 0.003″ brass) and oxidized black. Or, for example, interference bars could be printed on the inside of a clear panel.

In the illustrated example, the motion picture is a motion picture of horses running. That is, the motion picture is a sequence of frames 160,162,164 that when viewed in succession depict horses running.

Further in preferred embodiments, the base includes an inner cylindrical band forming the aperture and having the outwardly facing surface, and the panel includes an outer cylindrical band concentric with the inner cylindrical band such that the outwardly facing surface is visible through the openings.

In the illustrated example, the base 120 is an inner cylindrical band 120 that forms the aperture 110 and has the outwardly facing surface 140. Further in the illustrated example, the panel 130 is an outer cylindrical band 130 concentric with the inner cylindrical band 120 such that the outwardly facing surface 140 is visible through the openings 190.

Preferably, the inner cylindrical band forms an inner cylinder, the outer cylindrical band forms an outer cylinder and the bands are configured for rotational movement relative to one another about the longitudinal axis of the cylinders and constrained relative to one another in a direction parallel to the longitudinal axis of the cylinders.

In the illustrated example, the inner cylindrical band 120 forms an inner cylinder, the outer cylindrical band 130 forms an outer cylinder and the bands 120,130 are configured for rotational movement relative to one another about the longitudinal axis of the cylinders and constrained relative to one another in a direction parallel to the longitudinal axis of the cylinders. Stated plainly for example, the outer cylindrical band 130 can be “spun around” the inner cylindrical band 120 such that the openings 190 pass over the outwardly facing surface 140.

It should be understood that the panel 130 may be rotated from right to left so that the motion picture depicted on the outwardly facing surface 140 appears to be moving from left to right. The faster the panel 130 is rotated with respect to the base 120, the faster the motion picture will run. When the panel 130 is rotated in the opposite direction (e.g., from left to right), then the motion picture depicted on the outwardly facing surface 140 will appear to run backwards (e.g., from right to left).

It should be understood that in certain alternate embodiments, the ring 100 may be configured such that the panel 130 may be rotated from left to right so that the motion picture depicted on the outwardly facing surface 140 appears to be moving from right to left. The faster the panel 130 is rotated with respect to the base 120, the faster the motion picture will run. When the panel 130 is rotated in the opposite direction (e.g., from right to left), then the motion picture depicted on the outwardly facing surface 140 will appear to run backwards (e.g., from left to right). However, the present general inventive concept is not limited thereto.

In alternative embodiments, the ring 100 may be configured such that the animation may appear to move in the same direction the panel 130 is rotated.

It should further be understood that in certain other alternate embodiments, the ring 100 may be configured such that the outwardly facing surface 140 depicts a motion picture that moves perpendicular to the circumference of the ring 100 (e.g., moves up and down instead of left or right), when the panel 130 is rotated relative to the base 120 in either rotational direction.

Further in preferred embodiments, as to each frame, each frame is included in the image as a plurality of evenly spaced slices of the frame that when viewed together present the frame.

In the illustrated example, as to each frame 160,162,164, each frame 160,162,164 is included in the image 150 as a plurality of evenly spaced slices of the frame that when viewed together present the frame. For example, as illustrated, the first frame 160 includes 17 first frame slices 1601, 1602, 1603, 1604, 1605, 1606, 1607, 1608, 1609, 1610, 1611, 1612, 1613, 1614, 1615, 1616 and 1617 through 1617; the second frame 162 includes 17 second frame slices 1621, 1622, 1623, 1624, 1625, 1626, 1627, 1628, 1629, 1630, 1631, 1632, 1633, 1634, 1635, 1636 and 1637; and the third frame 164 includes 17 third frame slices 1641, 1642, 1643, 1644, 1645, 1646, 1647, 1648, 1649, 1650, 1651, 1652, 1653, 1654, 1655, 1656 and 1657.

In FIGS. 4 and 7, the slices depicting the first frame 160 are viewable through the openings 190 when the panel 130 is at a first location relative to the base 120.

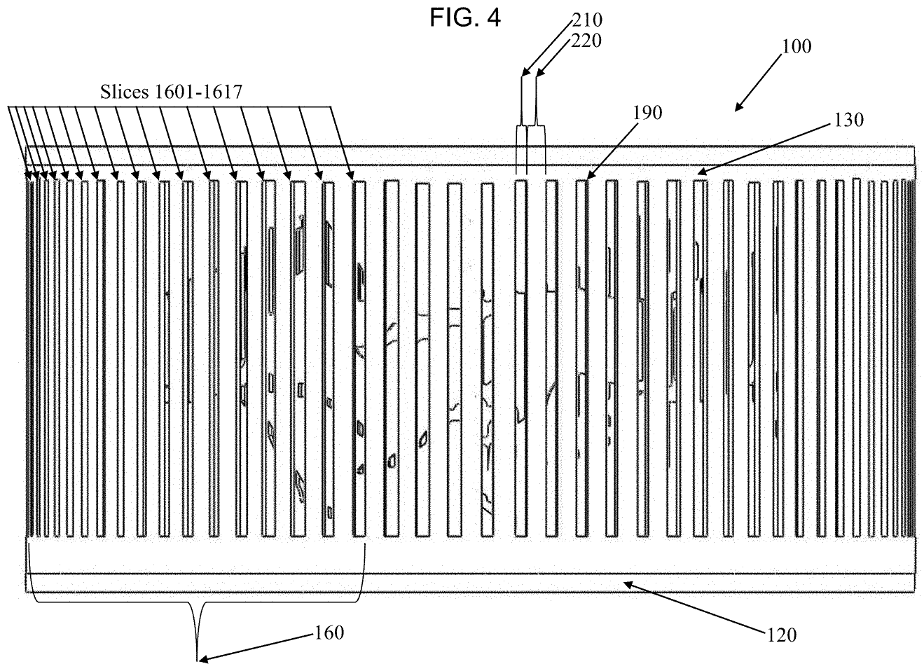

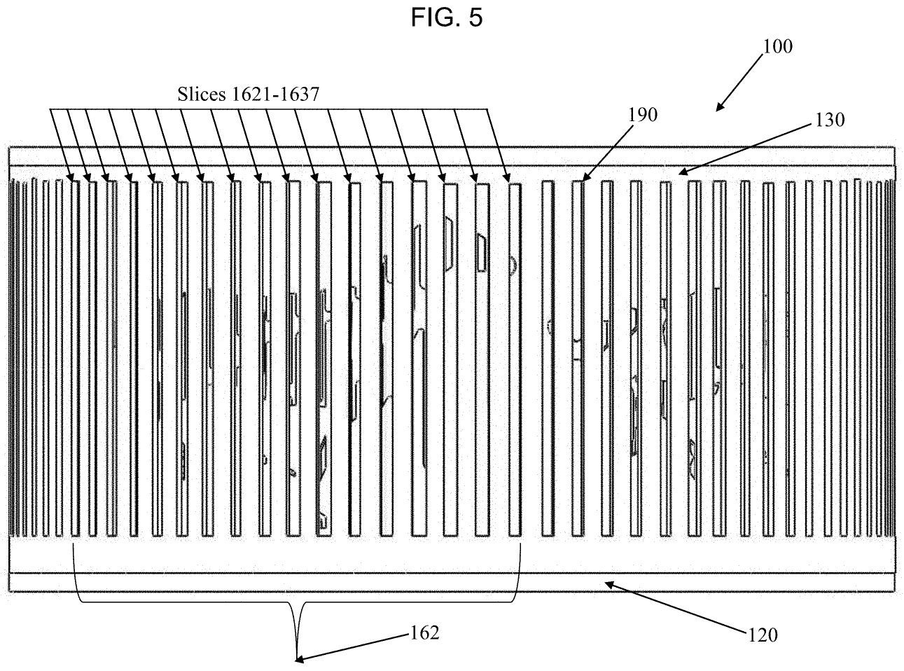

In FIGS. 5 and 8, the slices depicting the second frame 162 are viewable through the openings 190 when the panel 130 is at a second location relative to the base 120.

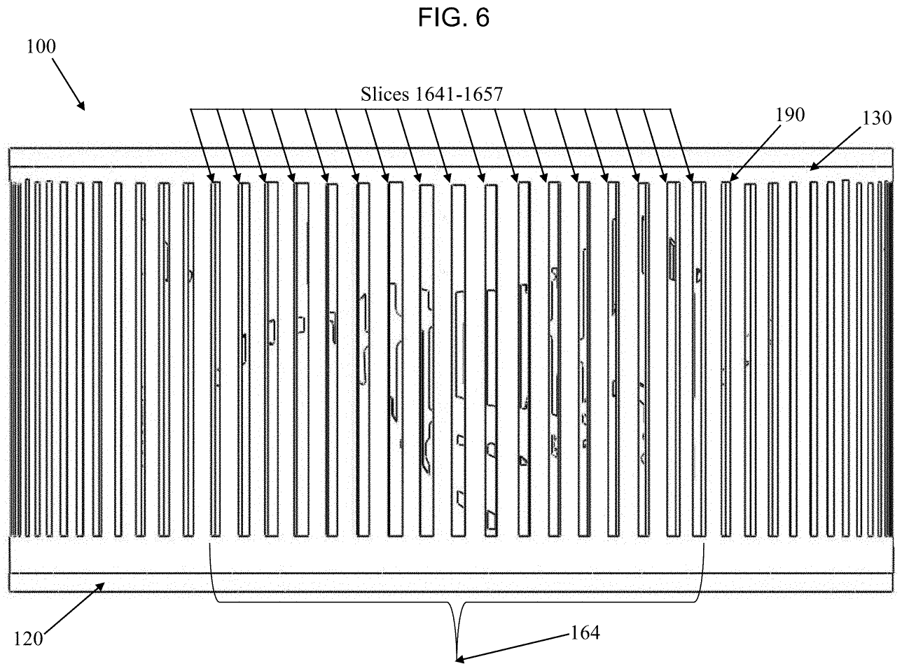

In FIGS. 6 and 9, the slices depicting the third frame 164 are viewable through the openings 190 when the panel 130 is at a third location relative to the base 120.

Preferably, each frame has a same number of slices as every other frame, and the slices of the frames are sequentially interlaced to form the image.

In the illustrated example, each frame 160,162,164 includes several slices, and as shown, the slices are sequentially interlaced to form the image 150. For example, as illustrated, the slices are presented in the following order: 1601-1621-1641-1602-1622-1642-1603-1623-1643-1604-1624-1644-1605-1625-1645-1606-1626-1646-1607-1627-1647-1608-1628-1648-1609-1629-1649-1610-1630-1650-1611-1631-1651-1612-1632-1652-1613-1633-1653-1614-1634-1654-1615-1635-1655-1616-1636-1656-1617-1637-1657.

Accordingly, the slices are arranged such that each position of the panel 130 with respect to the base 120 shows a different subset of the slices depicted on the outwardly facing surface 140, where each subset of slices depicts a respective frame of the motion picture depicted on the outwardly facing surface 140. When the panel 130 is rotated with respect to the base 120 such that the motion picture depicted on the outwardly facing surface 140 runs in the forward direction, then the subsets of slices are displayed through the openings 190 in the panel 130 such that the frames 160,162,164 of the motion picture are displayed in the forward sequence (e.g., 160 then 162 then 164). And, when the panel 130 is rotated with respect to the base 120 such that the motion picture depicted on the outwardly facing surface 140 runs in the backward direction, then the subsets of slices are displayed through the openings 190 in the panel 130 such that the frames 160,162,164 of the motion picture are displayed in the backward sequence (e.g., 164 then 162 then 160).

Preferably, each opening has an opening width, the openings are spaced from adjacent openings by a spacing distance, each slice of the frame has a slice width equal to the opening width, and the slices of the frame are spaced from adjacent slices of the frame by a slice distance equal to the spacing distance.

In the illustrated example, each opening 190 has an opening width 210, the openings are spaced from adjacent openings by a spacing distance 220, each slice of the frame has a slice width 230 equal to the opening width 210, and the slices of the frame are spaced from adjacent slices of the frame by a slice distance 240 equal to the spacing distance 220.

Further preferably, the spacing distance is equal to the opening width multiplied by one less than the number of frames in the sequence.

In the illustrated example, the spacing distance 220 is equal to the opening width 210 multiplied by one less than the number of frames in the sequence.

In preferred embodiments, a first frame of the sequence appears to follow sequentially from a last frame of the sequence such that continuous movement is perceived as the frames are repeatedly viewed sequentially in a loop.

In the illustrated example, the first frame 160 of the sequence appears to follow sequentially from the last frame 164 of the sequence such that continuous movement is perceived as the frames 160,162,164 are repeatedly viewed sequentially in a loop.

### Methods

Motion Picture Preparation for Presentation

In preferred embodiments, a method of the invention for preparing a motion picture for presentation is for preparing a motion picture for presentation on a viewing surface of a viewing device having an aperture, a base having the viewing surface, and a panel configured for movement relative to the base and including a plurality of evenly spaced openings each having an opening width and being spaced from adjacent openings by a spacing distance.

As a non-limiting example, the method of the invention will be described with reference to the ring 100 previously illustrated and described. As illustrated and described, the ring 100 has a base 120 that has an outwardly facing surface 140 as a viewing surface 140. The base 120 has an aperture 110. The ring 100 also has a panel 130 configured for movement relative to the base 120. The panel 130 includes a plurality of evenly spaced openings 190. Each of the openings 190 has an opening width 210 and is spaced from adjacent openings by a spacing distance 220.

In preferred embodiments, the method includes preparing a number of adjacent frames in a sequence forming the motion picture.

Referring now also to FIG. 18, in the present example, the method includes in S510 preparing a number of adjacent frames 160,162,164 in a sequence forming the motion picture.

Preferably, the frames are prepared as silhouettes.

In the present example, the frames 160,162,164 are prepared as silhouettes.

Preferably, the frames are prepared at a size and resolution such that later when they are converted to an interlaced image 152 as described below, and the interlaced image 152 is duplicated to prepare the series image 154 as described below, the series image 154 will fit the length of the viewing surface and appear clear on the viewing surface.

It should be understood that the frames can be prepared, for example, by obtaining a video of a desired motion picture, isolating each frame of the video, and selecting a desired number of the isolated frames (in this example, three frames). While three frames are selected in this example, the present invention is not limited to this range and any suitable range is possible.

Known technologies exist for undertaking these activities. For example, a Scalable Vector Graphics (SVG) formatting may be used to create the silhouettes. Further, for example, the frames can be converted from a screen resolution to a print resolution to appear clear when applied to the viewing surface. However, it should be understood that any suitable technologies, now known or later invented, can be used to undertake these activities.

Preferably, a first frame of the sequence appears to follow sequentially from a last frame of the sequence such that continuous movement is perceived as the frames are repeatedly viewed sequentially in a loop.

In the present example, the first frame 160 of the sequence appears to follow sequentially from the last frame 164 of the sequence such that continuous movement is perceived as the frames 160,162,164 are repeatedly viewed sequentially in a loop. Stated alternatively for example, the first frame 160 should appear to plausibly follow sequentially from the third frame 164 in order to give the illusion of smooth continuous movement from the third frame 164 to the first frame 160.

In preferred embodiments, the method includes, as to each frame, converting the frame into a plurality of evenly spaced slices of the frame that when viewed together present the frame, such that each slice of the frame has a slice width equal to the opening width, the slices of the frame are spaced from adjacent slices of the frame by a slice distance equal to the spacing distance, and each frame has a same number of slices as every other frame.

In the present example, the method includes in S520, as to each frame 160,162,164, converting the frame into a plurality of evenly spaced slices of the frame that when viewed together present the frame. For example, as illustrated, the first frame 160 includes 17 first frame slices 1601, 1602, 1603, 1604, 1605, 1606, 1607, 1608, 1609, 1610, 1611, 1612, 1613, 1614, 1615, 1616 and 1617 through 1617; the second frame 162 includes 17 second frame slices 1621, 1622, 1623, 1624, 1625, 1626, 1627, 1628, 1629, 1630, 1631, 1632, 1633, 1634, 1635, 1636 and 1637; and the third frame 164 includes 17 third frame slices 1641, 1642, 1643, 1644, 1645, 1646, 1647, 1648, 1649, 1650, 1651, 1652, 1653, 1654, 1655, 1656 and 1657.

Further for example, as illustrated, each slice of each frame has a slice width 230 equal to the opening width 210.

Further for example, as illustrated, the slices of each frame are spaced from adjacent slices of the frame by a slice distance 240 equal to the spacing distance 220, and each frame has a same number of slices as every other frame.

Preferably, the spacing distance is equal to the opening width multiplied by one less than the number of frames in the sequence.

In the illustrated embodiment, the spacing distance 220 is equal to the opening width 210 multiplied by two, which is one less than three (the number of frames in the sequence).

In preferred embodiments, the method includes sequentially interlacing the slices of the frames to form an interlaced image.

In the present example, the method includes in S530 sequentially interlacing the slices of the frames 160,162,164 to form an interlaced image 152. For example, each frame 160,162,164 includes 17 slices, and as shown in FIG. 18 (which shows representations of only 5 slices of each frame), the slices are sequentially interlaced to form the interlaced image 152. For example, as illustrated, the slices are presented in the following order: 1601-1621-1641-1602-1622-1642-1603-1623-1643-1604-1624-1644-1605-1625-1645-1606-1626-1646-1607-1627-1647-1608-1628-1648-1609-1629-1649-1610-1630-1650-1611-1631-1651-1612-1632-1652-1613-1633-1653-1614-1634-1654-1615-1635-1655-1616-1636-1656-1617-1637-1657.

In preferred embodiments, the method includes preparing a series image to fit a length of the viewing surface by duplicating end-to-end in series the interlaced image.

In the present example, the method includes in S540 preparing a series image 154 by duplicating end-to-end in series the interlaced image 152.

For example, the series image 154 can be accomplished by duplicating the interlaced image 152 as many times as necessary for the total length of all of the interlaced images to be equal to the circumference of the cylindrical outwardly facing surface 140.

Preferably, the viewing surface is cylindrical and has a circumference, and the length equals the circumference.

In the present example, the viewing surface 140 is cylindrical and has a circumference, and the length equals the circumference.

In preferred embodiments, the method further includes applying the series image to the viewing surface.

In the present example, the method includes in S550 applying the series image 154 to the viewing surface 140.

For example, the series image may be applied to the viewing surface 140 through various processes including, but not limited to, inkjet printing, laser printing, sublimation printing, rotary pad printing, etching, burning, and laser engraving. Preferably, the series image is secured with a clear protective coating.

It should be understood that the color of the base 120, the panel 130, the viewing surface 140, the frames and the frame background may be of any desired color, or alternating sequence of colors.

It should be understood that a glow in the dark base material can be used for the outwardly facing surface 140 and then be printed on with non-glow ink, to allow the animated effect of the ring 100 to be visible in poor lighting.

In certain embodiments, one or more drops of diluted essential oil can be placed between the base 120 and the panel 130 to offer an additional form of sensory stimulation. The oil also acts as a lubricant to allow for smoother and quieter movement, and accordingly allow for fidgeting without distraction.

User-Directed Motion Picture Preparation

In preferred embodiments, another method of the invention is for user-directed preparation of a motion picture for presentation on a viewing surface of a viewing device having an aperture, a base having the viewing surface, and a panel configured for movement relative to the base and including a plurality of evenly spaced openings each having an opening width and being spaced from adjacent openings by a spacing distance.

As a non-limiting example, the method of the invention will be described with reference to the ring 100 previously illustrated and described. As illustrated and described, the ring 100 has a base 120 that has an outwardly facing surface 140 as a viewing surface 140. The base 120 has an aperture 110. The ring 100 also has a panel 130 configured for movement relative to the base 120. The panel 130 includes a plurality of evenly spaced openings 190. Each of the openings 190 has an opening width 210 and is spaced from adjacent openings by a spacing distance 220.

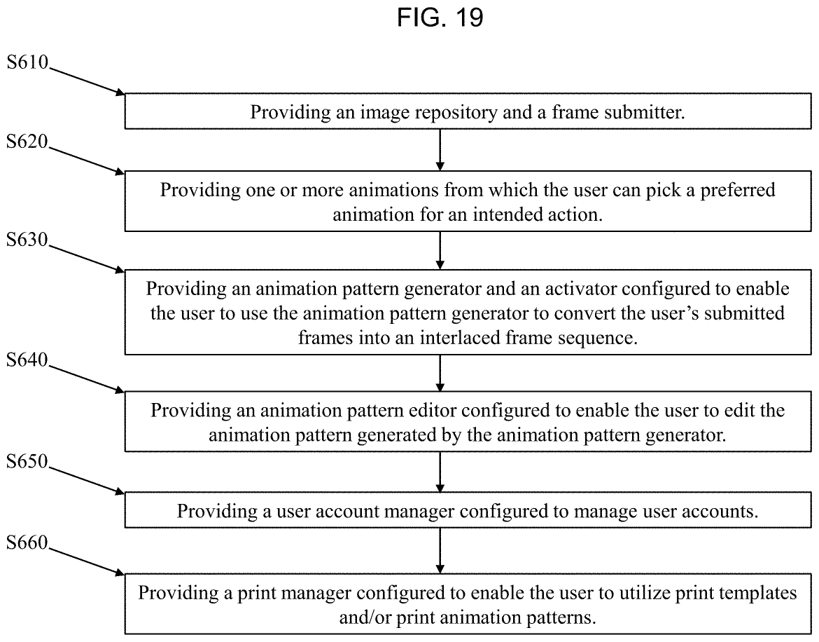

Referring now also to FIG. 19, in preferred embodiments, the method includes (e.g., as in S610) providing an image repository (e.g., a database) and a frame submitter (e.g., an image file uploader) configured to enable a user to submit (e.g., upload to the database) a plurality of frames of an animation.

Preferably, the user has been provided with one or more guidelines providing direction for optimizing the frames for preparation. Preferably, the guidelines include one or more of: (1) choose a subject that can be well represented in 3 frames and (2) choose colors that work best for the design and the viewing device.

As to (1), preferably, the guidelines include one or more of: (a) side profile walk and run cycles work well; (b) the subject should be wider than it is tall; and (c) abstract patterns work well. With regard to (1)(a), the method in certain embodiments preferably includes providing to the user a selection of images of movement cycles for a range of subjects, that the user can reference. With regard to (1)(c), the method in certain embodiments preferably includes providing for use by the user an abstract pattern generator (e.g., kaleidoscope-type generator) that easily generates frames of shape animations to the user's preference.

As to (2), preferably, the guidelines include one or more of: (a) silhouettes work best; (b) different colors can be chosen, but color combinations with high contrast have the best results; (c) the color of the subject is recommended to match the color of the bars in the viewing device; and (d) choose a color that is not too rich, to maintain crisp non-distorted printings.

In preferred embodiments, the method includes (e.g., as in S620) providing one or more animations from which the user can pick a preferred animation for an intended action including but not limited to one or more of the following: (1) use as-is for preparation for presentation; and (2) retrieve (e.g., download) for modification (e.g., for editing) and re-submit (e.g., re-upload).

In preferred embodiments, the method includes (e.g., as in S630) providing an animation pattern generator configured to convert submitted frames into an interlaced frame sequence (e.g., of a type described above), and an activator configured to enable the user to use the animation pattern generator to convert the user's submitted frames into an interlaced frame sequence (e.g., of a type described above).

Preferably, the animation pattern generator is configured to present a preview of an animation based on the generated interlaced frame sequence (e.g., a two-dimensional animation movie in a designated portion of a device screen).

Further preferably, the animation pattern generator is configured to present a photorealistic three dimensional rendering of a viewing device (e.g., a ring 100) of the present invention that would present the previewed animation.

In preferred embodiments, the method includes (e.g., as in S640) providing an animation pattern editor configured to enable the user to edit the animation pattern generated by the animation pattern generator.

Preferably, the animation pattern editor is configured to enable the user with editing tools including one or more of cropping frames, panning frames, drawing images, overlaying images, undoing previous actions, redoing recent actions, and saving changes.

In preferred embodiments, the method includes (e.g., as in S650) providing a user account manager configured to manage user accounts, including but not limited an account of the user. Preferably, the animation pattern generator and/or the animation pattern editor is configured to save the animation pattern to the user's account.

In preferred embodiments, the method includes (e.g., as in S660) providing a print manager configured to enable the user to utilize print templates and/or print animation patterns.

With regard to utilizing print templates, the print manager preferably provides a print template with a plurality of animation pattern slots (e.g., 20 animation pattern slots), each being a place for an animation pattern. Further preferably, for each animation pattern slot, a plurality of test print slots (e.g., 3 test print slots) for confirming that for each printed animation pattern, the print is aligned properly and the colors are correct. Preferably, the test print slots are automatically generated from a section of a selected animation pattern. Preferably, the user account tracks which animation pattern slots have been used, so future animation patterns can be assigned to unused slots until the animation pattern slots are full. This provides for efficient use of each print template.

With regard to printing animation patterns, the print manager preferably exports test prints and animation patterns as separate printable files (e.g., Portable Document Format, or PDF, files). Preferably, the user is provided with one or more waterproof sticker sheets with blank stickers that are pre-cut with precise dimensions of the viewable surface of the viewing device (e.g., ring 100). Further preferably, each of the sheets has markings indicating the correct orientation of the page when being placed into a printer. Further preferably, the print manager provides print instructions for optimal printing results and enables changing print settings in accordance with the instructions.

The present general inventive concept provides apparatuses and methods related to wearable devices configured to mechanically present motion pictures. An example wearable device includes an aperture configured for fitting placement about a body part, a base configured for remaining stationary adjacent the body part when the aperture is in place about the body part, and a panel configured for movement relative to the base. The base includes an outwardly facing surface presenting an image that includes a number of adjacent frames in a sequence forming a motion picture in which a first frame appears to follow sequentially from a last frame such that continuous movement is perceived as the frames are repeatedly viewed sequentially in a loop. The panel includes a plurality of evenly spaced openings through which the frames are viewable one at a time in sequence as the panel moves relative to the base. The openings are spaced from adjacent openings by a spacing distance equal to the width of each opening multiplied by one less than the number of frames in the sequence. Each frame is included in the image as a plurality of evenly spaced slices that when viewed together present the frame. Each slice has a slice width equal to the opening width. The slices of the frame are spaced from adjacent slices of the frame by a slice distance equal to the spacing distance. Each frame has a same number of slices as every other frame. The slices of the frames are sequentially interlaced to form the image. However, the present general inventive concept is not limited thereto.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A wearable device, comprising:
an aperture configured for placement about a body part;
a base configured for remaining adjacent the body part when the aperture is in place about the body part;
a panel configured for movement relative to the base; wherein
the base includes an outwardly facing surface presenting an image,
the image includes a number of adjacent frames in a sequence forming a motion picture, and
the panel includes a plurality of evenly spaced openings through which the frames are viewable one at a time in sequence as the panel moves relative to the base.

2. The device of claim 1, wherein the aperture is configured for fitting placement about the body part, and the base is configured for remaining stationary adjacent the body part when the aperture is in place about the body part.

3. The device of claim 1, wherein the base includes an inner cylindrical band forming the aperture and having the outwardly facing surface, the panel includes an outer cylindrical band concentric with the inner cylindrical band such that the outwardly facing surface is visible through the openings.

4. The device of claim 3, wherein the inner cylindrical band forms an inner cylinder, the outer cylindrical band forms an outer cylinder and the bands are configured for rotational movement relative to one another about the longitudinal axis of the cylinders and constrained relative to one another in a direction parallel to the longitudinal axis of the cylinders.

5. The device of claim 1, wherein as to each frame, each frame is included in the image as a plurality of evenly spaced slices of the frame that when viewed together present the frame.

6. The device of claim 5, wherein each frame has a same number of slices as every other frame, and the slices of the frames are sequentially interlaced to form the image.

7. The device of claim 5, wherein each opening has an opening width, the openings are spaced from adjacent openings by a spacing distance, each slice of the frame has a slice width equal to the opening width, and the slices of the frame are spaced from adjacent slices of the frame by a slice distance equal to the spacing distance.

8. The device of claim 7, wherein the spacing distance is equal to the opening width multiplied by one less than the number of frames in the sequence.

9. The device of claim 1, wherein each opening has an opening width and the openings are spaced from adjacent openings by a spacing distance equal to the opening width multiplied by one less than the number of frames in the sequence.

10. The device of claim 1, wherein a first frame of the sequence appears to follow sequentially from a last frame of the sequence such that continuous movement is perceived as the frames are repeatedly viewed sequentially in a loop.

11. The device of claim 10, wherein each opening has an opening width and the openings are spaced from adjacent openings by a spacing distance equal to the opening width multiplied by one less than the number of frames in the sequence.

12. The device of claim 11, wherein as to each frame, each frame is included in the image as a plurality of evenly spaced slices of the frame that when viewed together present the frame.

13. The device of claim 12, wherein each frame has a same number of slices as every other frame, and the slices of the frames are sequentially interlaced to form the image.

14. The device of claim 13, wherein each slice of the frame has a slice width equal to the opening width, and the slices of the frame are spaced from adjacent slices of the frame by a slice distance equal to the spacing distance.

15. A method of preparing a motion picture for presentation on a viewing surface of a viewing device having an aperture, a base having the viewing surface, and a panel configured for movement relative to the base and including a plurality of evenly spaced openings each having an opening width and being spaced from adjacent openings by a spacing distance, the method comprising:
preparing a number of adjacent frames in a sequence forming the motion picture;
as to each frame, converting the frame into a plurality of evenly spaced slices of the frame that when viewed together present the frame, such that each slice of the frame has a slice width equal to the opening width, the slices of the frame are spaced from adjacent slices of the frame by a slice distance equal to the spacing distance, and each frame has a same number of slices as every other frame;
sequentially interlacing the slices of the frames to form an interlaced image; and
preparing a series image to fit a length of the viewing surface by duplicating end-to-end in series the interlaced image.

16. The method of claim 15, wherein a first frame of the sequence appears to follow sequentially from a last frame of the sequence such that continuous movement is perceived as the frames are repeatedly viewed sequentially in a loop.

17. The method of claim 15, wherein the viewing surface is cylindrical and has a circumference, and the length equals the circumference.

18. The method of claim 15, wherein the frames are prepared as silhouettes.

19. The method of claim 15, wherein the spacing distance is equal to the opening width multiplied by one less than the number of frames in the sequence.

20. The method of claim 15, further comprising applying the series image to the viewing surface.
